(19) United States
(12) Patent Application Publication
(10) Pub. No.: US 2003/0192111 A1
(43) Pub. Date: Oct. 16, 2003

(54) Emergency apparel with fiber optic display

(76) Inventor: David Galoob, Moss Beach, CA (US)

Correspondence Address: CHRISTOPHER J. ROURK, AKIN, GUMP, STRAUSS, HAUER & FELD, L.L.P., P O BOX 688, DALLAS, TX, 75313-0688, US

(21) Appl. No.: 10/124,256

(22) Filed: Apr. 16, 2002

(51) Int. Cl. A62B 17/00; A41D 13/00

(52) U.S. Cl. 2/457

(57) ABSTRACT

An article of clothing with embedded optical fibers is provided, such as one that includes a display formed by the light emitting ends of the optical fibers. A strobing unit connected to the display provides strobed light to the display through the optical fibers, so that emergency workers can be readily identified by an observer even in darkness, rain, smoke, fog, or other conditions where visibility is limited.

### FIELD OF THE INVENTION

The present invention is related to apparel having implanted optical fibers, and is more specifically related to apparel and signage for emergency and safety workers that includes strobing optical fiber displays, nomenclature, and other features that enhance the ability of emergency workers to be located.

### BACKGROUND OF THE INVENTION

Articles of clothing with embedded optical fibers or other light sources are known in the art. These articles of clothing generally include aesthetic displays or designs that are formed from the light emitting ends of optical fibers. A light generation unit, such as light emitting diodes, is attached to the optical fibers and generates light that causes the display to be visible. In some displays, the lights change color, or are sequenced so as to create an appearance of motion in the display.

Although such clothing with embedded fiber optic displays is known, it has typically been used only for aesthetic purposes. Having light emitting designs on clothing inherently increases the visibility of the clothing, but no additional features have been provided other than aesthetic features by such existing fiber optic embedded clothing designs. For example, while light-emitting designs have been provided that identify the wearer, no additional features have been provided that do more than simply provide increased visibility of such wearer to observers. Thus, if an observer were looking for a specific person, prior art systems would not assist the observer in making such a determination.

### SUMMARY OF THE INVENTION

In accordance with the present invention, emergency apparel with an embedded fiber optic display is provided that overcomes known problems with emergency apparel.

In particular, emergency apparel with an embedded fiber optic display is provided that utilizes strobing in a manner that makes it easier for observers to locate emergency workers based on the function performed by the emergency worker.

In accordance with an exemplary embodiment of the present invention, an article of clothing with embedded optical fibers is provided, such as one that includes a display formed by the light emitting ends of the optical fibers. A strobing unit connected to the nomenclature display provides fast, slow, or randomized strobed light to the display through the optical fibers, so that emergency workers can be readily identified by an observer even in darkness, rain, smoke, fog, or other conditions where visibility is limited.

The present invention provides many important technical advantages. One important technical advantage of the present invention is an article of clothing with an embedded optical fiber nomenclature display that emits strobed light. Unlike constant lighting or animated displays, strobed light is more visible in conditions where visibility is limited, and allows text, nomenclature, or other features to be more readily distinguished so as to facilitate the identification of the function performed by the wearer of the article of clothing.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of an article of clothing in accordance with an exemplary embodiment of the present invention;

FIG. 2 is a diagram of an article of clothing that includes an active display and uniform reflective patterns throughout the article of clothing in accordance with an exemplary embodiment of the present invention;

FIG. 3 is a diagram of an article of clothing that includes a multi-dimensional reflective feature in accordance with an exemplary embodiment of the present invention;

FIG. 4 is a diagram of an article of clothing in accordance with an exemplary embodiment of the present invention;

FIG. 5 is a diagram of a system for providing strobing functionality for an article of clothing in accordance with an exemplary embodiment of the present invention;

FIG. 6 is a flow chart of a method for manufacturing an article of clothing with embedded fiber optics in accordance with an exemplary embodiment of the present invention; and

FIG. 7 is a flow chart of a method for providing strobe rate controls to a display on an article of clothing in accordance with an exemplary embodiment of the present invention.

### DETAILED DESCRIPTION OF PREFERRED EMBODIMENTS

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

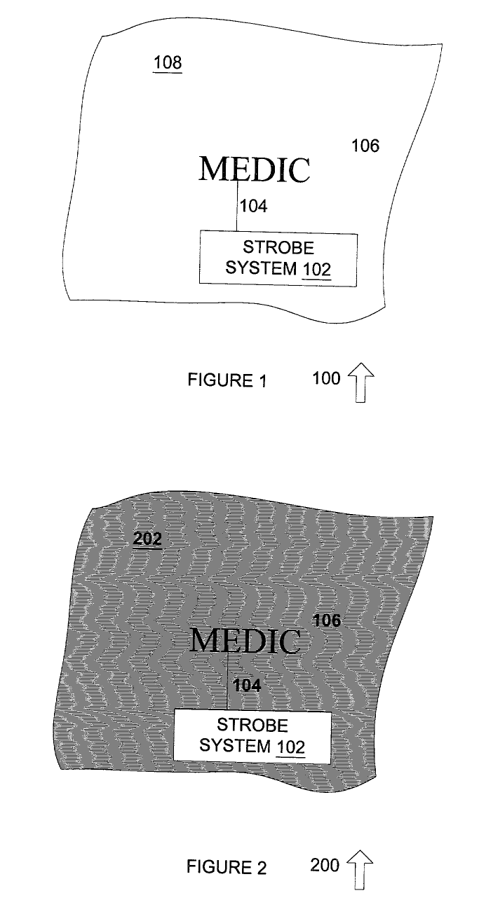

FIG. 1 is a diagram of an article of clothing 100 in accordance with an exemplary embodiment of the present invention. Article of clothing 100 can be a coat, shirt, hat, pants, or other suitable articles of clothing tat include an embedded fiber optic design with strobed light that increases the noticeability of the fiber optic design, such as when safety personnel wear the clothing in order to be easily recognized by members of the public or persons requiring their services.

Article of clothing 100 includes strobe system 102 that is coupled via optical fibers 104 to display 106. In one exemplary embodiment, strobe system 102 can be implemented in hardware, software, or a suitable combination of hardware and software, and can be one or more hardware systems, one or more software systems operating on a processing platform, or other suitable systems. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of software in a specific purpose software application.

Strobe system 102 is coupled to display 106 through optical fibers 104. As used herein, the term “couple” and its cognate terms, such as “couples” and “coupled,” can include a physical connection (such as a fiber optic conductor), a virtual connection (such as through randomly assigned memory locations of a data memory device), a logical connection (such as through logical gates of a semiconducting device), other suitable connections, or a suitable combination of such connections. In one exemplary embodiment, systems and components are coupled to other systems and components through intervening systems and components, such as through an operating system of a digital signal processor.

Strobe system 102 allows display 106 to be more readily identified by an observer, such as to allow the observer to make out words, nomenclature, or to otherwise locate the wearer when the observer is looking for the wearer under conditions that make viewing difficult, such as darkness, smoke, fog, rain, or a combination of such conditions. In one exemplary embodiment, display 106 can be formed by the ends of a plurality of light emitting fibers, such as ganged fibers placed into a light emitting diode housing, or where each fiber end is otherwise connected to strobe system 102 through optical fibers 104. In another exemplary embodiment, a splitter or other suitable optical device can be used to reduce the number of optical fibers that must be connected through optical fibers 104 to strobe system 102.

Material 108 can be a natural, synthetic, or hybrid fabric or other material on which display 106 is provided. Strobe system 102 can be physically attached to material 108, can be placed in a pocket of material 108, can be worn on a belt such that strobe system 102 is coupled to optical fibers 104, or other suitable configurations for material 108 can be provided.

In operation, article of clothing 100 is used to provide display 106 on material 108 for use by suitable personnel. In one exemplary embodiment, emergency personnel such as medical personnel, firemen, police, or other suitable personnel can wear article of clothing 100 with display 106 that is illuminated by strobe system 102. Strobe system 102 can cause display 106 to blink at a rate that makes display 106 noticeable. In this exemplary embodiment, the rate can be adjusted so as to be noticeable when standing still, to appear to be constant when standing still but to appear to flash when moving so as to provide increased noticeability when the wearer of article of clothing 100 is moving, to conserve battery power, to compensate for scintillating or fluorescent fibers (such as to turn off strobing when the optical fibers are emitting light from some other source), to allow the user to control the strobe rate, or in other suitable embodiments. Likewise, the rate of strobing can be adjusted to make different teams of personnel identifiable to team captains, to make persons having different functions easier to differentiate to observers, or for other suitable purposes that result in easier identification of the wearer's identity or function.

Article of clothing 100 and other suitable articles of clothing described herein can also be a patch that is attached to another article of clothing, such as with velcro, snaps, or other suitable connectors so as to allow the fiber optic design, nomenclature, words, symbols, or other features that are illuminated to be changed, to allow a discharged strobing system 102 to be replaced with one that is fully powered, or for other suitable purposes. In one exemplary embodiment, the patch can also be attached to a handle and used as a sign, such as by using velcro, snaps or other suitable connectors.

FIG. 2 is a diagram of an article of clothing 200 that includes an active display and uniform reflective patterns in accordance with an exemplary embodiment of the present invention. Article of clothing 200 includes strobe system 102 that is coupled to display 106 through optical fibers 104. In addition, article of clothing 200 has a reflective pattern 202 placed on it that is formed from a reflective material, such as with a rotary screen, a roller screen, flat-bed screen printing techniques, or other suitable techniques. In this manner, reflective pattern 202 is painted, heat bonded, or otherwise incorporated onto the cloth. In one exemplary embodiment, a reflective microspherical pattern printing material or other suitable chemical compound formed from chemical binders that can contain 80% aluminum and 20% glass microspheres in a heat treatable slurry can be used to create the repeated pattern. The reflective material can reflect in 160 degrees of arc or more in one exemplary embodiment. The repeated pattern can be provided on a portion of article of clothing 200, on the entire surface of article of clothing 200, or in other suitable configurations. In one exemplary embodiment, the pattern can be words, stripes, safety designs, commercially recognized safety symbols, or other suitable designs.

In operation, article of clothing 200 provides active and passive features for increasing the visibility of the wearer. In conjunction with strobe system 102 and display 106, the reflective pattern on article of clothing 200 allows the wearer to be readily distinguished at a distance, and further allows the function performed by the wearer to be readily identified by an observer. For example, in prior art systems in which reflective materials were applied to clothing, the primary purpose of the reflectivity was to increase the noticeability of the wearer. Nevertheless, although noticeability can be increased through the use of reflective materials, the wearer will not be visible if there is no light being shown on the wearer. Likewise, reflective materials that are used to identify the wearer are generally used to help the wearer avoid from being struck by a vehicle or to otherwise provide an indication of where the wearer is. Article of clothing 200 includes features that allow the function performed by the wearer to be identified, such as to allow the wearer to be identified in the dark by an observer without a flashlight or other lighting device, and to allow the wearer to be more readily located when such a light device is shined on the wearer.

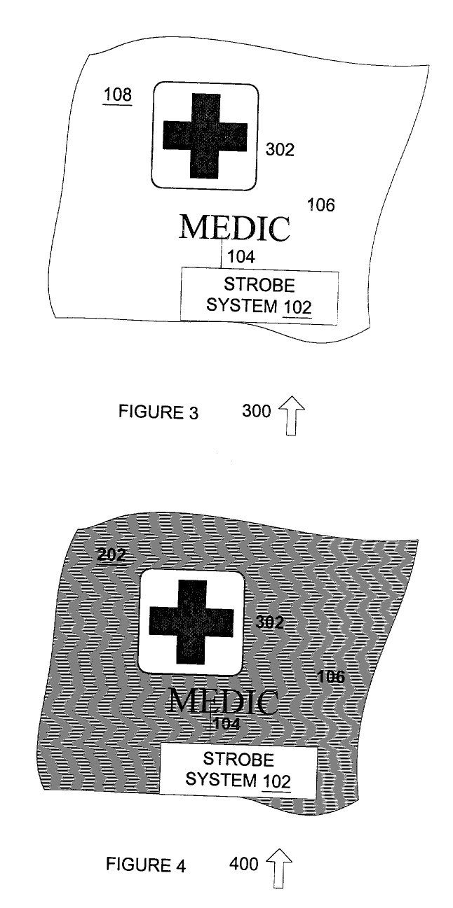

FIG. 3 is a diagram of an article of clothing 300 that includes a multi-dimensional reflective feature in accordance with an exemplary embodiment of the present invention.

Article of clothing 300 includes strobe system 102 and display 106, and further includes multi-dimensional reflective feature 302. Multi-dimensional reflective feature 302 can be formed from polyvinyl chloride (PVC) or other suitable materials that can include a reflective material that has angular surfaces disposed about multi-dimensional reflective feature 302. Thus, the reflective surfaces of multi-dimensional reflective feature 302 can reflect based on the angle of the viewer to the plane of multi-dimensional reflective feature 302. In this manner, a viewer can identify both the location and function of the wearer of article of clothing 300 by either multi-dimensional reflective feature 302, display 106, or both multi-dimensional reflective feature 302 and display 106. Likewise, if the battery for display 106 wears out, then multi-dimensional reflective feature 302 can also be used to provide passive identification of the wearer of article of clothing 300. Likewise, multi-dimensional reflective feature 302 can be used in conjunction with display 106, such as to spell the same words spelled by display 106 so as to provide active and passive identification of the wearer of article of clothing 300.

FIG. 4 is a diagram of an article of clothing 400 in accordance with an exemplary embodiment of the present invention. Article of clothing 400 includes both active display 106, reflective pattern 202, and multi-dimensional reflective feature 302, so as to increase the noticeability of the wearer of article of clothing 400 and to allow observers to determine a function performed by the wearer. Providing reflective pattern 202 on article of clothing 400 with multi-dimensional reflective feature 302 increases the passive identification capability for observers of wearers of article of clothing 400. Likewise, by providing display 106 with article of clothing 400, the wearer of article of clothing 400 can be readily identified by a person and can be easily located in situations where visibility is poor, such as in the rain, in the dark, in a smoky environment, in fog, or in other similar environments.

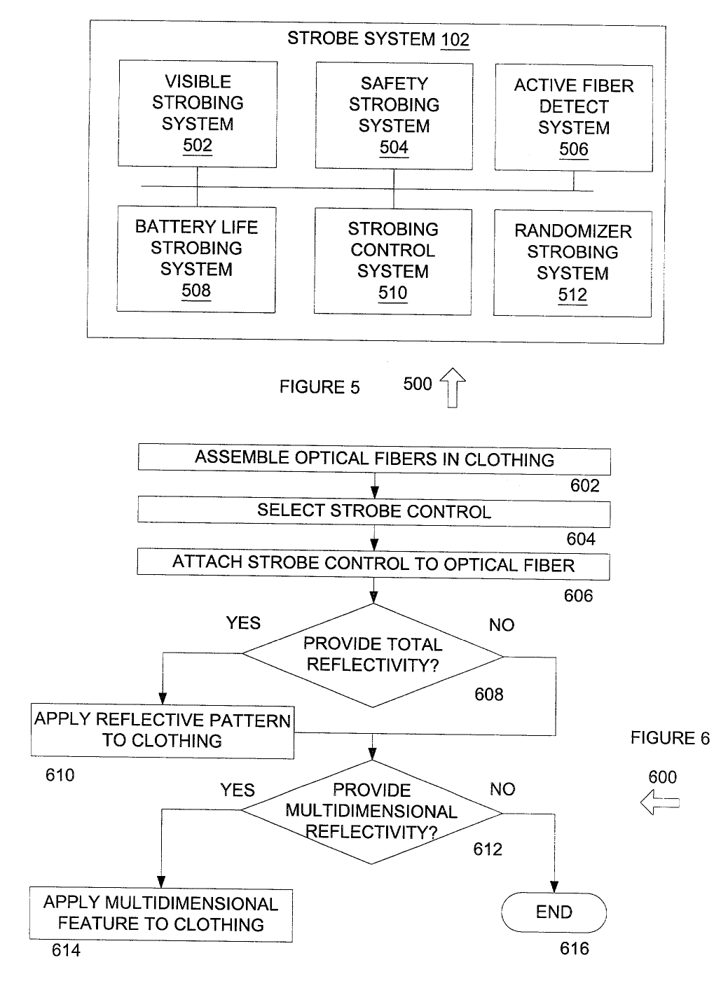

FIG. 5 is a diagram of a system 500 for providing strobing functionality for an article of clothing in accordance with an exemplary embodiment of the present invention. System 500 includes strobe system 102 and visible strobing system 502, safety strobing system 504, active fiber detect system 506, battery life strobing system 508, strobing control system 510, and randomizer strobing system 512, each of which can be implemented in hardware, software, or a suitable combination of hardware and software, and which can be one or more hardware systems, or one or more software systems operating on a suitable processor platform.

Visible strobing system 502 generates strobe rate data that causes a strobe light to strobe at a rate that creates a visible strobing effect. In one exemplary embodiment, visible strobing system 502 can provide strobe rate data that allows strobing to occur at a rate that has been determined to be optimally visible for a wearer that is standing still, such as less than 20 flashes per second. In this manner, visible strobing system 502 can be provided alone or as a selectable strobing system to provide strobing functionality.

Safety strobing system 504 provides strobe rate data to strobe a light at a rate that appears to be constant to an observer if the wearer of the strobe system is standing still, but which creates an optical effect that is more noticeable than a constant light to the observer if the wearer of the article of clothing is moving. Depending on the rate of motion, strobing may be intermittently or continuously apparent during movement. In one exemplary embodiment, safety strobing system 504 can strobe the light at a rate faster than 30 flashes per second, which can be a length of time or a number of flashes per second perceivable by the human eye to be constant, or slower than 30 flashes per second. Safety strobing system 504 can also increase the amount of time between each flash such as to increase the noticeability of the strobing light when the wearer is moving. Thus, for a stationary “frame,” 30 flashes per second might appear to an observer to be a constant light. However, for a moving frame, the number of “frames” presented to the observer will be less than 30 per second. In this manner, safety strobing system 504 creates an effect that increases the noticeability of a display that is being strobed. If the display is used to spell the safety function of a wearer such as medical personnel, policemen, parking attendants, hazardous chemical clean up crews, firemen, paramedics, or other suitable safety personnel, or to illuminate symbols or other features that identify a safety function, the noticeability can be increased so as to allow observers that require services from such safety personnel to readily locate them even in a low light environment such as in the dark, in the rain, in a smoky environment, or in other suitable low light environments.

Active fiber detect system 506 detects when a scintillating or florescent fiber is generating light, and is “active” in the sense that it is generating light from a source other than a strobing unit such that strobing does not need to be provided, and generates control data that causes the strobing system to be turned off. Active fiber detect system 506 can thus stop the strobing to conserve battery power or otherwise allow scintillating or florescent fibers to provide light sources or light when available. Active fiber detect system 506 can also turn the strobing system back on when the scintillation has stopped or reached a level at which strobing is desirable.

Battery life strobing system 508 generates strobe rate data that maximizes battery life. In one exemplary embodiment, battery life strobing system 508 can include selectors that allow a user to select the strobing rate based on the amount of time or life that the battery must last. In another exemplary embodiment, battery life strobing system 508 can be used in conjunction with visible strobing system 502, safety strobing system 504, and active fiber detect system 506 to provide strobing at a rate that performs the functions of these other systems but which maximizes the battery life.

Strobing control system 510 allows a user to select a strobe rate. In one exemplary embodiment, strobing control system 510 can include a user selectable control such as a potentiometer, digital controls, or other suitable controls, such that the user can increase or decrease the strobe rate, enter a strobe rate, or provide strobe rate control data in other suitable manners. Strobing control system 510 can also be used in conjunction with other strobing systems such as visible strobing system 502, safety strobing system 504, active fiber detect system 506, and battery life strobing system 508, such as to allow a wearer of strobing control system 510 to select from one or more control selections for one or more of these systems.

Randomizer strobing system 512 generates randomized or non-periodic strobing rates that increase the noticeability of a display that is illuminated by light strobed at the randomized rates. In one exemplary embodiment, the display can be strobed at randomized rates using randomizer strobing system 512 that appear to be constant when the display is stationary, but where the randomized strobing rate is noticeable when the display is moving. Other suitable randomized rates can also or alternatively be used.

In operation, system 500 provides strobing for a display on an article of clothing in a manner that facilitates or enhances safety features of the article of clothing. System 500 can be used to strobe the light used to illuminate a display so that the strobing is visible when the wearer is standing still, so that the strobing rate appears to be constant when the wearer is standing still but creates a noticeable effect that draws attention to the wearer when the wearer is moving, can turn off strobing when active or scintillating fibers are being used, can be used to prolong battery life, and can allow a user to select the strobe rate. In this manner, system 500 enhances the noticeability of a wearer of an optical display so as to allow the function of the wearer to be readily determined by others who may require services from the wearer.

FIG. 6 is a flow chart of a method 600 for manufacturing an article of clothing with passive and active lighting in accordance with an exemplary embodiment of the present invention. Method 600 allows articles of clothing to be manufactured that include strobing functions and passive reflective features that enhance the use of the article of clothing for safety purposes, such as for wearing by safety personnel to allow the safety personnel to be readily identified, as opposed to simply increasing the noticeability of a wearer of the article of clothing.

Method 600 begins at 602 where optical fibers are assembled in the clothing. In one exemplary embodiment, the optical fibers can be used to spell out an identifying title of the wearer, such as “POLICE,” “MEDIC,” “PARAMEDIC,” “PARKING ATTENDANT,” “HAZARDOUS CHEMICAL HANDLER,” “RADIATION PERSONNEL,” or other suitable personnel. In this exemplary embodiment, sequencing can be used to create the display, such as when two or more words are used to identify the wearer, the first word can be illuminated followed by the second word. Other suitable display configurations can likewise be used. The method then proceeds to 604.

At 604, a strobe control is selected for provision with the article of clothing. In one exemplary embodiment, the strobe control can be selected based upon the function of the wearer, the expected application (such as for use in the dark, in rain, in smoke, or other suitable applications), or based upon other suitable use parameters. The strobe control can likewise be selected by the wearer prior to putting on the article of clothing, at the time of manufacture, such as where the strobe control is to be permanently attached to the article of clothing, or in other suitable manners. The method then proceeds to 606.

At 606, the strobe control is attached to the optical fibers of the display. In one exemplary embodiment, the optical fibers of the display can be gathered into a bundle, and the bundle can be configured for attachment to the strobe control. Likewise, optical fiber splitters, or other suitable devices can be used to concentrate the optical fibers or to otherwise make the optical fibers amenable for insertion into the strobe control. The method then proceeds to 608.

At 608 it is determined whether total reflectivity for the article of clothing is to be provided. For example, the entire article of clothing can be provided with reflective patterning, reflective patterns can be provided to portions of the article of clothing such as stripes or safety symbols or words, or other suitable reflectivity patterning can be provided. If it is determined at 608 that total reflectivity is not required the method proceeds to 612. Otherwise the method proceeds to 610 where a reflective pattern is applied to the clothing. In one exemplary embodiment, a textile reflective microspherical pattern printing can be used, such as using 80% aluminum and 20% glass microspheres as previously described or other suitable materials. In this exemplary embodiment, both active and passive identification devices are used to increase the viewability or observability of the wearer. Likewise, the reflective pattern can include words and symbols that also identify the safety function of the wearer, such as to allow observers to identify the wearer when the active strobing illumination of the display runs out of batteries.

At 612 it is determined whether multi-dimensional reflectivity is to be provided. In one exemplary embodiment, the multi-dimensional reflectivity can include polyvinyl chloride or other suitable materials that are reflective along planar faces, where an embossed feature such as a symbol or word is provided that has planar faces viewable by observers at different angles. If it is determined at 612 that a multi-dimensional reflective feature is to be provided the method proceeds to 614, where the multi-dimensional feature is applied to the clothing. In one exemplary embodiment, the feature can be heat embossed, can be a detachable patch or other suitable application and procedures can be used. Otherwise, if it is determined at 612 that a multi-dimensional reflective feature is not to be provided the method proceeds to 616 and terminates.

In operation, method 600 allows an article of clothing to be manufactured for safety personnel, to increase the ability of observers to identify the function performed by the safety personnel so that the safety personnel can be contacted for assistance. In this manner, method 600 provides both active and passive identification indicia, such as reflective features, reflective features that are applied to the entire article of clothing, multi-dimensional features that increase the ability of the observer to notice the wearer, active features, or other suitable features. Method 600 thus allows articles of clothing to be manufactured that provide features beyond those that simply increase the visibility of the wearer, and allow additional information about the wearer to be communicated in a manner that increases the ability of the information to be transmitted to the observer.

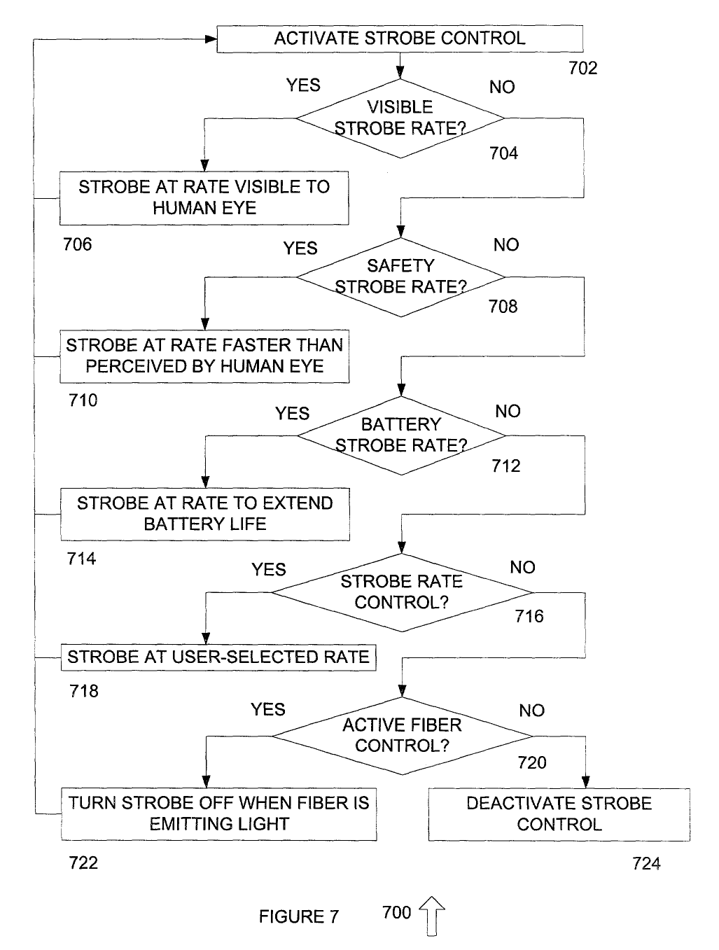

FIG. 7 is a flow chart of a method 700 for providing strobe rate controls to a display on an article of clothing in accordance with an exemplary embodiment of the present invention. Method 700 allows the strobe rate for a display on an article of clothing to be controlled so as to enhance the ability of observers to identify the function of the wearer and location of the wearer, to prolong battery life, and to provide other suitable functions.

Method 700 begins at 702 where a strobe control is activated. In one exemplary embodiment, the strobe control can be activated when an optical fiber bundle is inserted into the strobe control, when the switch is turned on, or in other suitable manners. The method then proceeds to 704.

At 704 it is determined whether a visible strobe rate is to be provided. In one exemplary embodiment, the visible strobe rate can include a strobe rate that facilitates the ability of observers to notice the strobing effect when the wearer is standing still. For example, strobing at rates slower than 20 to 30 flashes per second will usually allow the strobe rate to be detected by the observer. Likewise, the length of time between flashes and the amount of dark time between flashes can be adjusted, so as to decrease the amount of dark time, increase the amount of dark time, or in other suitable manners. If it is determined at 704 that a visible strobe rate is not required the method proceeds to 708. Otherwise the method proceeds to 706 where a strobe rate is generated that causes the display to flash at a rate visible to the human eye. The method then returns to 702.

At 708 it is determined whether a safety strobe rate is required. In one exemplary embodiment, the safety strobe rate can be strobing of a light at a rate that appears constant when the wearer is standing still but which will be visible to the observer and noticeable thus drawing attention to the wearer when the wearer is moving. In this exemplary embodiment, strobing at a rate faster than approximately 30 flashes per second may be perceived to be constant to a human observer, but depending on the amount of dark time between flashes and the rate at which the wearer is moving, may increase the visibility of the wearer by creating a visual phenomenon that is unusual and which attracts attention to the wearer. If it is determined at 708 that a safety strobe rate is not required the method proceeds to 712. Otherwise the method proceeds to 710 where a strobe rate is generated that is faster than perceived by the human eye but which has other features to optimize the noticeability when the wearer is moving. The method then returns to 702.

At 712 it is determined whether a battery strobe rate is required to provide battery life of a predetermined period, to maximize battery life for certain modes of operation, or for other suitable battery conserving strobe rates. If it is determined at 712 that a battery strobe rate is not required the method proceeds to 716. Otherwise the method proceeds to 714 where the strobe rate is adjusted to extend the battery life in accordance with preset or user selected parameters. The method then returns to 702.

At 716 it is determined whether a strobe rate control that allows a user to select the strobe rate is being used. If the user is not selecting the strobe rate the method proceeds to 720, otherwise the method proceeds to 718 where the user selected strobe rate is used to set the rate of strobing. In one exemplary embodiment, the user can select the rate of strobing, the amount of dark time between flashes (such as a percentage of the cycle), or other suitable parameters. The method then returns to 702.

At 720 it is determined whether active fiber control is provided. If active fiber control is not provided the method proceeds to 724 where the strobe control is deactivated. Otherwise the method proceeds to 722 where the strobe is turned off when active fibers are emitting light. In one exemplary embodiment, scintillating or florescent fibers can be provided that receive ambient light and generate light that is used to illuminate the ends of the optical fibers. Likewise, florescent materials can be used that allow such scintillation to continue even after the ambient light source has been removed. At 722 the strobe light is turned off when such scintillating or florescent fibers are generating light, and the method returns to 702.

In operation, method 700 allows strobing of a display on an article of clothing in a manner that enhances the observability of the wearer of the article of clothing, allows a function of the wearer to be readily determined, prolongs battery life, and compensates for scintillating or florescent fibers. Method 700 thus allows the strobing for a display on an article of clothing to be optimized to enhance and assist with the safety functions of safety personnel.

In one exemplary embodiment, method 700 can be used to enhance the operations of safety personnel by allowing them to be readily identified by an observer according to a function performed by the wearer of an article of clothing. Method 700 thus allows policemen, paramedics, parking attendants, hazardous waste removal personnel, or other personnel to improve their ability to provide services by allowing observers to readily determine the function of the wearer of the article of clothing in any low visibility or visibility impaired environment, such as in the dark, in the rain, in fog, in smoke, in crowds, or in other areas where it is necessary to increase the ability for observers to determine a function performed by a person and the visibility of the person.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. An article of clothing with embedded optical fibers comprising:
a display formed by the light-emitting portions of the optical fibers that provides identifying information; and
a strobing unit coupled to the display, the strobing unit providing strobed light to the display through the optical fibers.

2. The article of clothing of claim 1 wherein the strobing unit further comprises a visible strobing system generating strobe rate data that causes the strobed light to flash at a rate that is visible to a human eye.

3. The article of clothing of claim 1 wherein the strobing unit further comprises a safety strobing system generating strobe rate data that causes the strobed light to flash at a rate that appears constant to a human eye when the article of clothing is stationary but which is noticeable when the article of clothing is moving.

4. The article of clothing of claim 1 wherein the strobing unit further comprises an active fiber detect system stopping the strobed light when the optical fibers are generating light.

5. The article of clothing of claim 1 wherein the strobing unit further comprises a battery life strobing system generating strobe rate data that causes the strobed light to flash at a rate that maximizes battery life.

6. The article of clothing of claim 1 wherein the strobing unit further comprises a strobing control system receiving generating user-selectable strobe rate data that causes the strobed light to flash at a rate selected by a user.

7. The article of clothing of claim 1 further comprising a reflective pattern applied to the article of clothing.

8. The article of clothing of claim 1 further comprising a multidimensional reflectivity feature applied to the article of clothing.

9. The article of clothing of claim 1 wherein the optical fibers are scintillating fibers.

10. A method for manufacturing an article of clothing with embedded optical fibers comprising:
installing the optical fibers in the clothing;
selecting a strobe control system generating strobed light; and
providing the strobe control system with the article of clothing.

11. The method of claim 10 wherein installing the optical fibers in the clothing comprises installing scintillating optical fibers in the clothing.

12. The method of claim 11 wherein selecting the strobe control system comprises selecting an active fiber detect system that stops the generation of strobed light when the optical fibers are generating light.

13. The method of claim 10 wherein selecting the strobe control system comprises selecting a visible strobing system generating strobe rate data that causes the strobed light to flash at a rate that is visible to a human eye.

14. The method of claim 10 wherein selecting the strobe control system comprises selecting a safety strobing system generating strobe rate data that causes the strobed light to flash at a rate that appears constant to a human eye when the article of clothing is stationary but which is noticeable when the article of clothing is moving.

15. The method of claim 10 wherein selecting the strobe control system comprises selecting a battery life strobing system generating strobe rate data that causes the strobed light to flash at a rate that maximizes battery life.

16. The method of claim 10 further comprising applying a reflective pattern to the article of clothing.

17. The method of claim 10 further comprising applying a multidimensional reflectivity feature applied to the article of clothing.
